(19) United States
(12) Patent Application Publication
(10) Pub. No.: US 2014/0046830 A1
(43) Pub. Date: Feb. 13, 2014

(54) Mobile Application For Monitoring and Managing Transactions Associated with Accounts Maintained at Financial Institutions

(71) Applicant: SWIPE ALERT, LLC, San Antonio, TX (US)

(72) Inventors: Jody J. Orozco, San Antonio, TX (US); John W. Tomblin, San Antonio, TX (US); David G. Modisette, San Antonio, TX (US)

(73) Assignee: SWIPE ALERT, LLC, San Antonio, TX (US)

(21) Appl. No.: 13/835,586

(22) Filed: Mar. 15, 2013

Related U.S. Application Data
(60) Provisional application No. 61/680,935, filed on Aug. 8, 2012.

(51) Int. Cl. G06Q 20/40

(52) U.S. Cl. CPC G06Q 20/4016
USPC 705/39

(57) ABSTRACT

A mobile application for sending alerts to a bank's customer is provided. The mobile application allows a customer to receive alert notifications regarding transactions on his or her bank or credit card accounts when a debit or credit card associated with the account is used. The mobile application server and adjoining intermediate database, which stores the customer's alert information, is in communication with the bank's or ISO's server and their adjoining customer database to receive transaction data. The mobile application server sends alert notifications through a customer's or user's mobile app after processing the communication, which displays the information on the customer's smartphone or electronic tablet. Customer may choose to send a response back through the mobile application server to the bank's or ISO's server and their adjoining customer database, reporting suspected fraud or approving the transaction using the customer's unique pin code or password.

### CROSS REFERENCE TO RELATED APPLICATIONS

This application claims the benefit of the filing date of U.S. Provisional Application Ser. No. 61/680,935, filed Aug. 8, 2012, which is incorporated by reference herein.

### BACKGROUND OF THE INVENTION

1. Field of the Invention

The present invention relates to mobile applications for IPhones®, PDA's, Blackberries®, and any other smart phone capable of running mobile applications thereon, as well as electronic tablets such as the IPad® or other similar electronic tablets capable of running mobile applications thereon. Specifically, the present invention relates to a mobile application running on an account holder's smartphone which can communicate with a financial institution's server via a mobile application server to monitor and manage transactions associated with the account holder's financial account with the financial institution.

The mobile application of the present invention receives information from the financial institution regarding a transaction when the account holder's credit card or debit card is used, and sends alerts or push notifications to the account holder's smartphone or tablet according to a predefined set of parameters associated with the account holder's account preferences. The mobile application of the present invention may send notification of a transaction either as or after it has occurred, or can send a pre-approval request before approving the transaction with the merchant. The mobile application also can determine the location of the account holder via the GPS location of the account holder's smartphone contemporaneous with the transaction to determine fraud. The financial institution's server can retrieve the GPS information retrieved by the mobile application from the mobile application server as a part of the financial institution's internal transaction approval process.

2. Description of the Related Art

Credit and debit card fraud have been escalating problems for Americans over the last decade. As technology improves, it becomes easier for thieves to steal the information they need to steal from one's checking or savings account, or run up a string of unauthorized credit card charges in a matter of minutes. Today, thieves need to have little or no contact with the actual authorized credit card or debit card to steal the information they need to duplicate the card and run fraudulent transactions.

Others have attempted to develop real-time fraud monitoring systems in the past to detect fraudulent transactions. However, such prior attempts focus either on determining the GPS location of an account holder's smartphone to determine if it is in close proximity to the merchant, or sending text messages or emails to the customer or card holder. Some systems usually simply notify a customer via text or email, while others obtain input from the customer.

A major problem with using email or text messages to alert the customer and obtain input from the customer is that both text messages and emails can easily be phished. Thus, prior systems that allow for interaction and user interface with the customer run the risk of being hacked and phished. As a result, a customer may enter valuable account information or other sensitive information to a phished email or text, thereby facilitating fraud, all the while believing he or she is responding to the fraud monitoring system. It is therefore desirable to provide a real-time, secure fraud alert service that monitors and manages credit or debit card transactions while resisting the ability to be phished by hackers.

### SUMMARY OF THE INVENTION

The present invention provides a secure fraud alert and monitoring service through a mobile application which sends push notifications for a customer to monitor transactions associated with his or her bank accounts and, in some embodiments, provides a graphical user interface to allow the customer to manage the transactions. As used herein a “bank” means any financial institution that maintains financial accounts and renders financial services for its customers, clients or members, including but not limited to banks, credit unions, and credit card companies. An “Independent Sales Organization,” or “ISO” is a third party credit card processing organization or company that also provides transaction processing services to banks A “customer” or “user” of the present invention means the holder of a financial account at a bank. The mobile application of the present invention is developed to be operated by the Apple iOS and Android operating systems. However, the present mobile application may also be adapted so that it may be operated by any other smart-phone or tablet operating systems. Therefore, although the term “smartphone” is used herein in conjunction with the mobile application of the present invention, it should be understood that “smartphone” includes any electronic device capable of running a mobile application thereon.

In one embodiment, the mobile application of the present invention comprises a mobile application running on a smartphone in communication with a mobile application server, which is also in communication with at least one bank server or ISO server which tracks and monitors a user's account activity, including credit card/debit card and/or online transactions. The mobile application software of the present invention is stored on the smartphone and communicates with the mobile application server. The mobile application server is a server in communication with a bank's server or an ISO's server, as well as the mobile app software on the user's smartphone, and has the mobile application database attached to it, which stores all of the relevant user profile information as well as relevant transaction data received by the bank or ISO, and responses thereto from the user through the mobile app on the user's smartphone. The “mobile app” on the smartphone (or the “user's mobile app”) sends the responsive data from the user to the mobile application server, which stores such information in the mobile application database and sends relevant responsive data to the bank's server or the ISO's server. As a security measure, the bank's or ISO's server has an intermediate database attached to be integrated with the server. The server informs this intermediate database sitting on the cloud of the transaction, which is then passed to the mobile application server/database in the cloud and then pushed out to the user's smartphone. Because the bank or ISO integrates the intermediary server/database it controls, it also prevents commination of credit card numbers to the mobile application server/database, because the intermediary server/database has the matching database of credit card numbers and names to user ID's. Because the lookup occurs at the bank/ISO and not on our main cloud, the mobile application need not store credit card numbers.

The user may download the mobile application through an app store such as the Apple App Store, the Android-based app store, or other similar mobile application delivery service. In one embodiment, the user may access the mobile application by logging onto his or her bank account and following prompts for information sent to the user by the mobile application server in communication with the bank's server, or if the bank has an ISO, the ISO's server. Finally, the mobile application server provides a web interface option which allows a user to access the user module through the internet to access or retrieve his or her password and/or change the user's preference filters. The user may also access his or her password and change his or her preference filters through the mobile app itself.

A bank or an ISO desiring to subscribe to the fraud monitoring service provided by the mobile application of the present invention provides certain information for entry into the mobile application database. Once the information of the bank or the ISO is in the database, the bank or ISO is given instructions on connecting to the mobile application server. Non-limiting examples of information required from a bank or ISO includes, but is not limited to, the bank or ISO name, user names and/or passwords, billing addresses, logos, and customer support personnel and customer support telephone number. At no point is there a direct connection to the bank's or ISO's server, but only the intermediate database that they integrate with as a part of the bank's internal transaction approval process.

In one embodiment of the present invention, the mobile application server of the present invention and the bank server establish a one way, bank server-to-mobile application server communication via internet communication. The internet communication may either be a secure connection, or a connection that is not secure. In an alternative embodiment, the communication between the mobile application server and the bank server is two-way, thereby allowing the mobile application server to communicate information back to the bank's server. The mobile application server of the present invention is in communication with the bank's server that communicates with the bank's customer account database and the bank's customer's debit/credit approvals. In another embodiment, the bank's server is replaced by an ISO's server in instances when a bank or banks use ISOs to process transactions of the bank's customers. In this embodiment, the ISO server establishes either one way to two way communication with the mobile application server and the bank's customer account database as described hereinabove. At no point is there a direct connection to the bank's or ISO's server, but only the intermediate database that they integrate with as a part of the bank's internal transaction approval process.

Every time a user's debit and/or credit card is used, the bank's server or the ISO's server where the bank uses an ISO, upon receiving the transaction data from the merchant's portal, activates the established communication with the mobile application server, and forwards the transaction data thereto. The mobile application server then accesses the intermediate database to identify the user's account. The intermediate database looks up the user account name based on the credit card number and only informs the mobile application server/database of the user name, thereby preventing the mobile application from knowing the credit card number associated with the transaction, and reads the data in the user's account preferences to determine whether to execute and send a push notification or alert notification to the user. In one embodiment, the mobile application server will send a push alert notification to the user's smartphone and/or electronic tablet every time the debit or credit card is used. However, in other embodiments, the mobile application server will only send push notifications or alert notifications to the user when the merchant transaction meets one or more of a set of predefined parameters set by the user.

The content of the push notification or alert notification may vary depending on the bank's requests and the user's preference filters in his or her profile in the mobile application database. In one embodiment, the push notification or alert notification comprises the name of the merchant and the amount of the proposed, pending or completed transaction. However, additional information may be provided, such as the location of the merchant (address), time of the requested transaction, time of the approved transaction, or other relevant information regarding the transaction.

When incoming transaction data is received by the mobile application server from the bank's server or the ISO's server if the bank uses an ISO, the mobile application server first identifies which bank's/ISO server is communicating the data. The mobile application then identifies the user's profile in the mobile application database, and records the transaction data therein. Depending on the embodiment, the mobile application server may perform a variety of steps after receiving and recording the transaction data. In one embodiment, the mobile application determines the GPS location of the user's smartphone or electronic tablet.

The mobile application server sends a communication to the application on the user's smartphone. When the user's smartphone receives the communication, the application thereon will obtain the GPS information, including the location and the time-stamp corresponding to the location from the smartphone or electronic tablet, and communicate that information back to the mobile application server. The mobile application server then stores that data in conjunction with the corresponding transaction data in the mobile application database. If the GPS location of the user's smartphone varies from the location of the merchant at the time of the transaction, a push notification or alert notification may be sent by the mobile application server to the intermediate database integrated with the bank's server or ISO's server. At no point is there a direct connection to the bank's or ISO's server, but only the intermediate database that they integrate with as a part of the bank's internal transaction approval process. The distance of variance may be predefined within the mobile application server, the intermediate database, or by the bank through web interface or interface with the mobile app on a smartphone.

In another embodiment of the present invention, the mobile application may be formatted to send a pre-approval alert notification to the user. In this embodiment, once the transaction data is received by the bank's server or the ISO server if the bank uses an ISO, the mobile application server sends an alert notification to the user, displaying the charge information to the user. The charge information comprises the amount and the merchant's name, and may also include the merchant's location by address and/or store number or other identifying information, and the time of the request for the transaction (i.e. the time corresponding to when the credit or debit card is swiped at the merchant's terminal).

At this point, the mobile application provides a graphical user interface, requiring the user to enter data to approve or decline the proposed transaction. As a further security measure, in one embodiment, the mobile application server requires the user to enter a password or pin code to access the alert notification and respond thereto. The entry of the pin code or password by the user serves as an authorizing digital signature. This measure helps ensure that the person receiving the notification is the user, and not somebody else merely in possession of the user's smartphone, such as a thief. In other embodiments, the password or pin code prompt may not be sent.

Once the pre-approval alert notification is communicated from the mobile application server to the user's smart phone, the pin number or password prompt is optionally displayed on the user's smartphone, and the user enters the correct pin number or password. The mobile application server sends a predefined set of prompts to the user's smartphone, including the information based on the personal filters in the user's profile, to allow the user to report to the mobile application server that he or she did not make the transaction. The mobile application server then passes the information to the intermediate database, and the bank or ISO server is informed through its integration with the intermediate database.

In another embodiment, the mobile application may require a post-transaction approval from the user. In this embodiment, a predefined set of prompts are sent to the user's smartphone after the correct pin number or password has been entered. The predefined set of prompts may include an “Approved” or “I Approve” prompt, a “Decline” or “I Decline” prompt, and optionally an “Unsure” or “I Am Unsure” prompt, or any other similar prompt that, at the very least, allows the user to either approve or decline the transaction, or report as fraudulent. Once the user selects the appropriate response from the prompts, the response is sent to the mobile application server, which sends the response data to the bank's server or the ISO's server via the intermediate database. Therefore, in the post-approval alert notification embodiment, the communication established between the mobile application server and the bank server or ISO's server should be a two-way communication.

In an alternative embodiment, the approval or decline process may reside solely with the user's bank, and may reside on the bank's server. If the bank uses an ISO to process transactions of the bank's customers, the approval or decline process may reside solely with the user's bank or the ISO, and may reside on the ISO's server. In these embodiments, only a post-transaction alert notification may be sent from the mobile application server to the user's smartphone upon receiving the transaction data, and the data associated with whether the bank's server or the ISO's server allowed or declined the transaction to the user. Upon receiving either an approved or declined notification from the mobile application server, the mobile app on the user's smartphone may display a prompt that allows the user to inform the bank or ISO of a fraudulent or unauthorized transaction.

In yet another embodiment, if the user's credit card or debit card is placed on hold or cancelled, the bank's server or ISO server may send an alert notification to the mobile application server, which in turn sends an alert notification to the user's mobile app. The alert notification may provide, alone or in combination, the last four digits of the credit or debit card, the contact information to the bank's customer support, and the message that is to be displayed to the user's smartphone. This functionality is provided so that the user can be alerted if/when his or her card is cancelled by the bank, when a new card is requested from the bank, when the card is expiring, when a request for a change of address or other contact information associated with the user's account with the bank is made, when a new card is mailed out, or to inform the bank of the receipt or lack of receipt of a new debit or credit card that has been mailed out.

### DESCRIPTION OF THE DRAWINGS

FIG. 1 is a flowchart showing a process of a bank or ISO acquiring the fraud monitoring services provided by the mobile application of the present invention;

FIG. 2 is a flowchart showing a process for a user to create a user account and profile by accessing the user module of the mobile application of the present invention;

FIG. 3 is a flowchart showing a process for a bank or ISO creating a user account and profile for its customer, or bank's customer, by accessing the website of the present invention to access the user module of the mobile application of the present invention;

FIG. 4 is a flowchart showing a process for a bank or ISO creating a user account and profile for its customer, or bank's customer, by allowing the bank's or ISO's automated system to access the user module of the mobile application of the present invention;

FIG. 5 is a flowchart showing a process for the Swipe Alert application to routinely download a bank's or ISO's list of users into a local copy of the database within their network of the present invention;

FIG. 6 is a flowchart showing a process for a bank/ISO sending transaction data to the mobile application server of the present invention;

FIG. 7 is a flowchart showing the mobile application server processing the transaction data received from the bank's or ISO's server;

FIG. 8 is a flowchart showing the mobile application server storing transaction data within the mobile application database and sending an alert notification to the user;

FIG. 9 is a flowchart showing a process for parsing and verifying transaction data received from the bank's or ISO's server;

FIG. 10 is a flowchart showing a process for determining the identity of the bank's or ISO's server sending the transaction data;

FIG. 11 is a flowchart showing a process for verifying the transaction data sent by the bank's/ISO's server;

FIG. 12 is a flowchart showing a process for the mobile application server locating the user's profile and associated information 112;

FIG. 13 is a flowchart showing a process for the mobile application server sending an alert notification 114 to the user;

FIG. 14 is a flowchart showing a process for the mobile application server sending an alert notification 114 to the user;

FIG. 15 is a flowchart showing a process for the mobile application server recording the GPS location of the user's smartphone;

FIG. 16 is a flowchart showing a process for the mobile application server sending an alert notification 114 to the user;

FIG. 17 is a flowchart showing a process for the mobile application server sending a pre-approval 116 alert notification 114 to the user;

FIG. 18 is a flowchart showing a process for the mobile application server sending a pre-approval 116 alert notification 114 to the user;

FIG. 19 is a flowchart showing a process for the mobile application server sending a pre-approval 116 alert notification 114 to the user;

FIG. 20 is a flowchart showing a process for the mobile application server sending a post-approval 118 alert notification 114 to the user; and

### DETAILED DESCRIPTION OF THE INVENTION

The mobile application of the present invention 10 comprises a mobile application server 11 working in conjunction with a mobile application database 15, and in communication with a third-party bank's server 24 or a third-party Independent Sales Organization's server 24 if the bank uses an ISO to process the transactions of the bank's customers' accounts, a mobile app 20 stored and executed on a smartphone, and mobile software application 25 stored on the mobile application server 11 and capable of reading and separating electronic data in a computer-readable medium. The mobile application database 15 is in communication with and is accessible by the mobile application server 11. In the preferred embodiment, the mobile application server 11 is a cloud-based server. However, other types of servers commonly known in the art may be used. The mobile application server 11 is also in communication with a user's mobile app 20. The mobile application database 15 stores all of the relevant information and data of the user 17 and the bank or ISO 13. In another embodiment, a local Swipe Alert database (15) is built within the bank's/ISO's (13) networking infrastructure. The database (15) stores their user's information (112) including, but not limited to, the user's user name and email address. When the bank/ISO (13) receives transaction data information (100), their automated system (23) will communicate with their local Swipe Alert database (15) to retrieve the appropriate user information (112) and then will send that information, along with the other transaction data information (100) to the Swipe Alert server (11). As shown in the figures, the term “Swipe Alert” refers to the trademark for the mobile application of the present invention 10. Thus Swipe Alert is synonymous with the mobile application of the present invention 10.

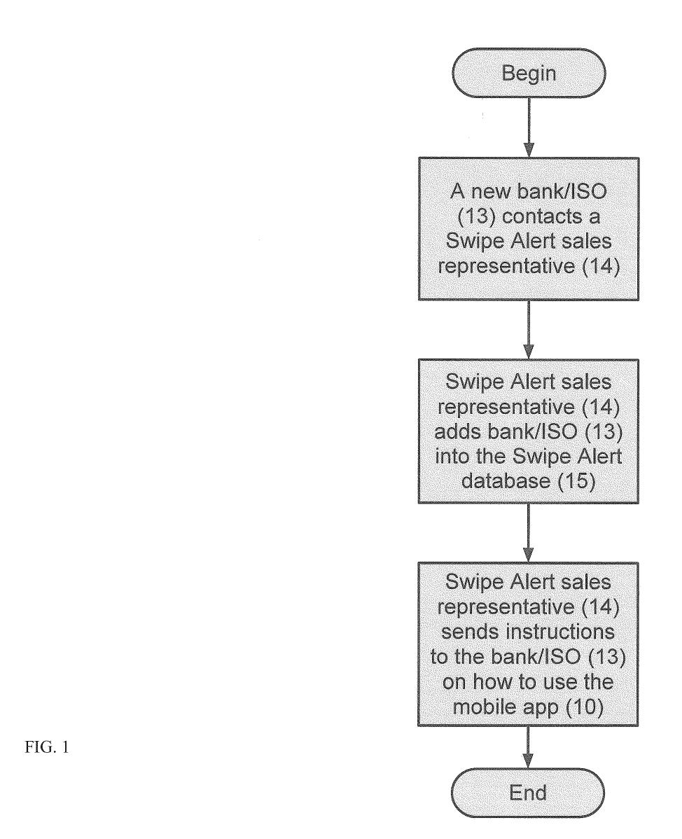

Referring to FIG. 1, the process 12 utilized by the mobile application 10 for a bank or ISO 13 to acquire the fraud protection and alert service is provided. As shown in FIG. 1, a bank or ISO 13 representative may contact a sales representative 14 to acquire the service provided by the mobile application 10, and after doing so, the sales representative 14 manually enters the pertinent information from the bank or ISO 13 into the mobile application database 15. Once the bank or ISO 13 is added into the mobile application database 15, communication is established between the mobile application server 11 and the bank's server or ISO's server 24. Thereafter, the sales representative 14 may electronically or manually send a set of instructions to the bank or ISO 13, instructing the bank or ISO 13 on the use of the mobile application 10. In other embodiments, a technical specialist (not shown) may interact with bank or ISO 13 representatives to set up the service either on-site, through live chat on the internet, or over the telephone (not shown).

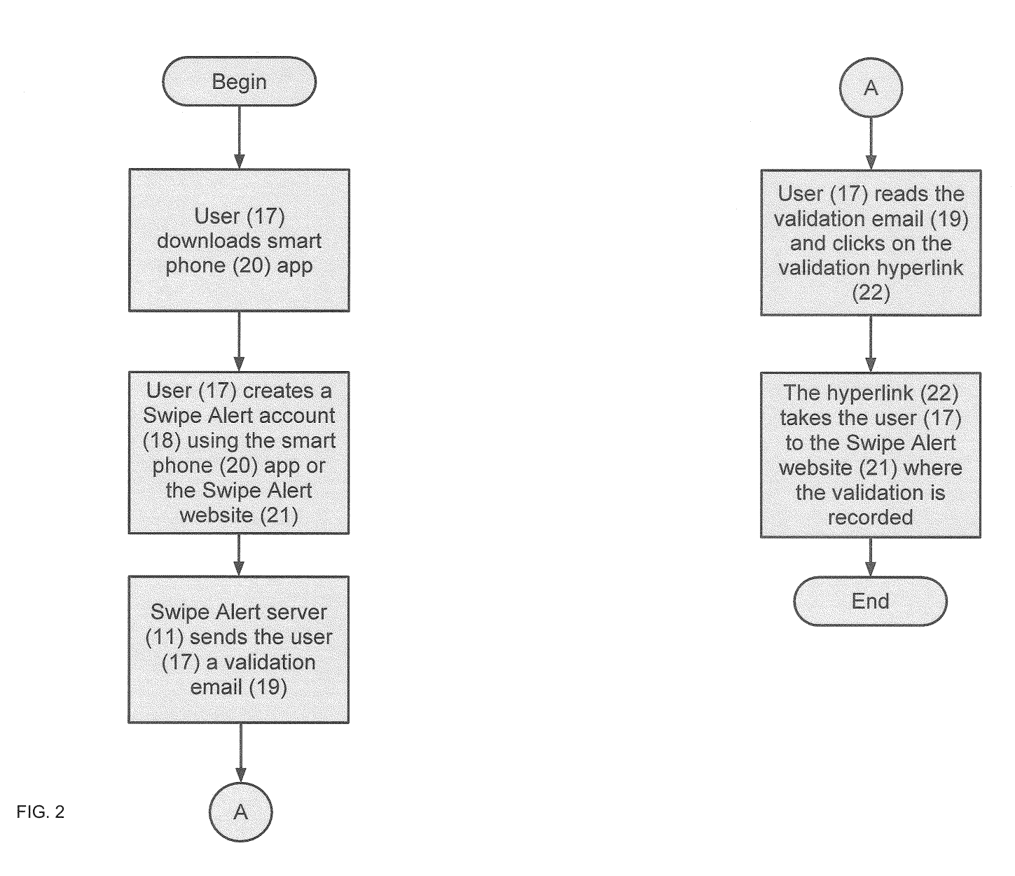

Referring to FIG. 2 through FIG. 4, the process 12 of an end user 17 to begin using the mobile application of the present invention 10 is disclosed. Once the bank or ISO 13 has acquired the service of the present invention 10, the bank's or ISO's customers or account holders may become users 17 of the mobile application 10. As shown in FIG. 2, in the preferred embodiment, the user 17 downloads the mobile application of the present invention 10 by accessing a mobile application store such as Apple's “App Store” (not shown) or other smartphone based app store (not shown).

Returning to FIG. 2, alternatively the user's mobile app 20 may be downloaded over the internet by accessing a website and downloading the user's mobile app 20 therefrom. Once the user's mobile app 20 is downloaded onto the user's smartphone, the user 17 creates a profile 112 which is stored in the mobile application database 15. The profile is created by the user's response to a series of predefined prompts for information, which may include the user's 17 account information with the bank or ISO 13, user names, identification, passwords, pin number, email address(es), security questions, and, in some embodiments, parameters for sending pre-approval alert notifications or push alerts to the user 17. The predefined prompts may also include, in one or more embodiments, processes 12 to be triggered by the mobile application of the present invention 10, such as determining the GPS coordinates of the user's smartphone, sending a pre-approval request to the user's smartphone, or sending a post transaction confirmation to the user's smartphone 20. These predefined prompts are sent by the mobile application server 11 to the user's smartphone 20, and the information entered by the user 17 in response is communicated back to the mobile application server 11, and stored in the mobile application database 15. After the user's profile is created 112, a validation email 19 is sent to the user's email account, and the user 17 validates the created profile, which is then recorded in the mobile application database 15.

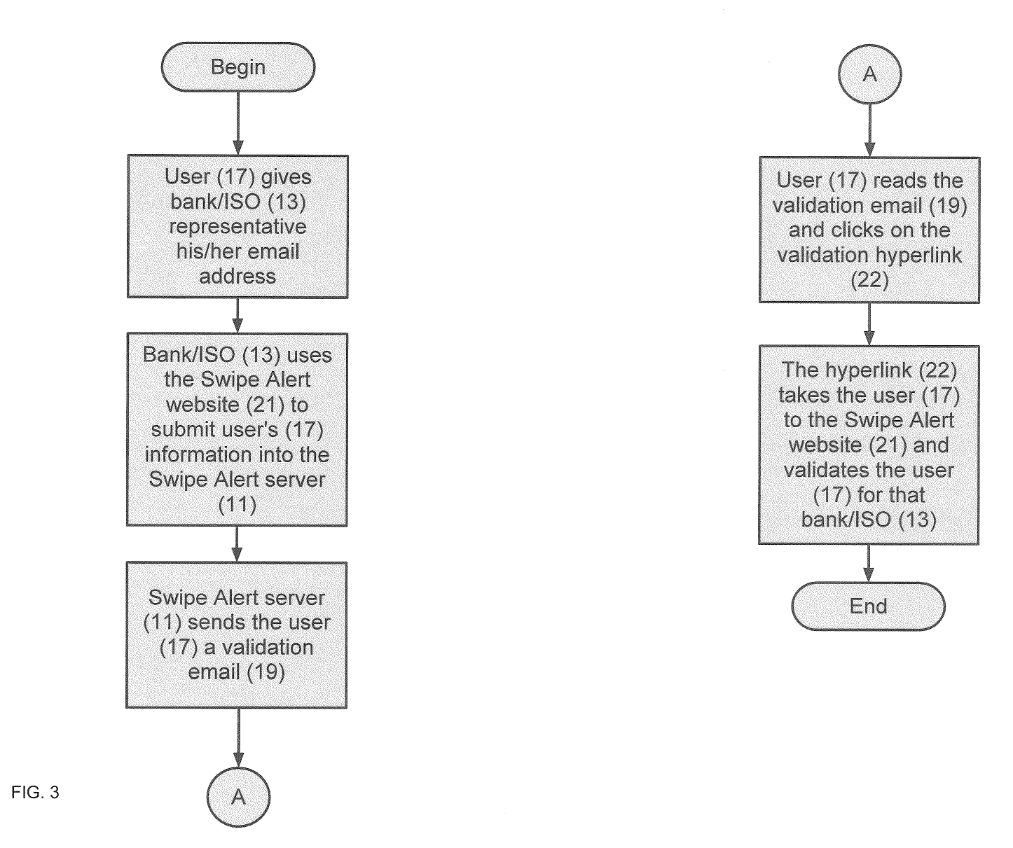

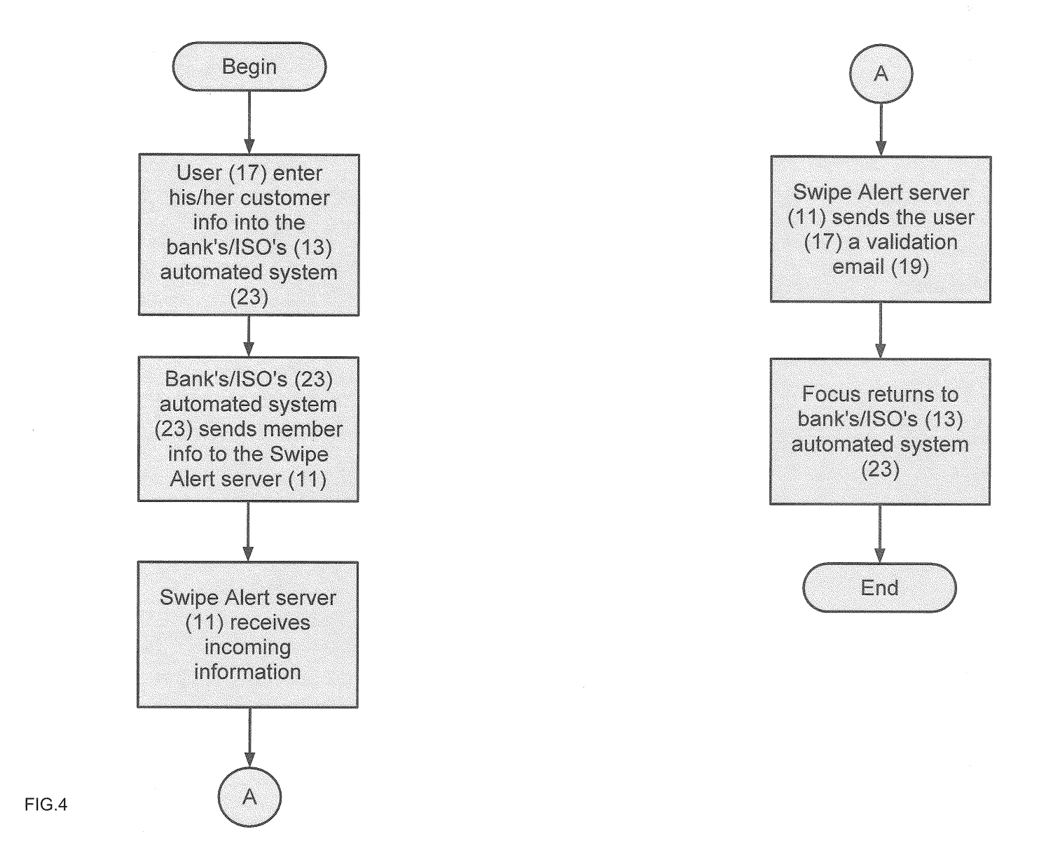

Referring to FIG. 3, in an alternative embodiment, the user's profile is created by the bank or ISO 13. A bank or ISO representative creates the profile for the user 17 through their website 23, and the validation email 19 is sent to the user 17. Once the user validates the profile, it is saved in the mobile application database 15. Referring to FIG. 4, in another alternative embodiment, the user 17 submits the profile information to the bank or ISO 13 through the bank or ISO's automated system 24, and a bank or ISO representative enters it into the bank's or ISO's server 24, which communicates the profile information to the mobile application server 11. The mobile application server 11 then sends a validation email 19 to the user 17, and stores the user's profile into the mobile application database 15 once the profile is validated. In another embodiment, the user 17 can create his or her profile either through the bank's or ISO's website or through the mobile application website 21.

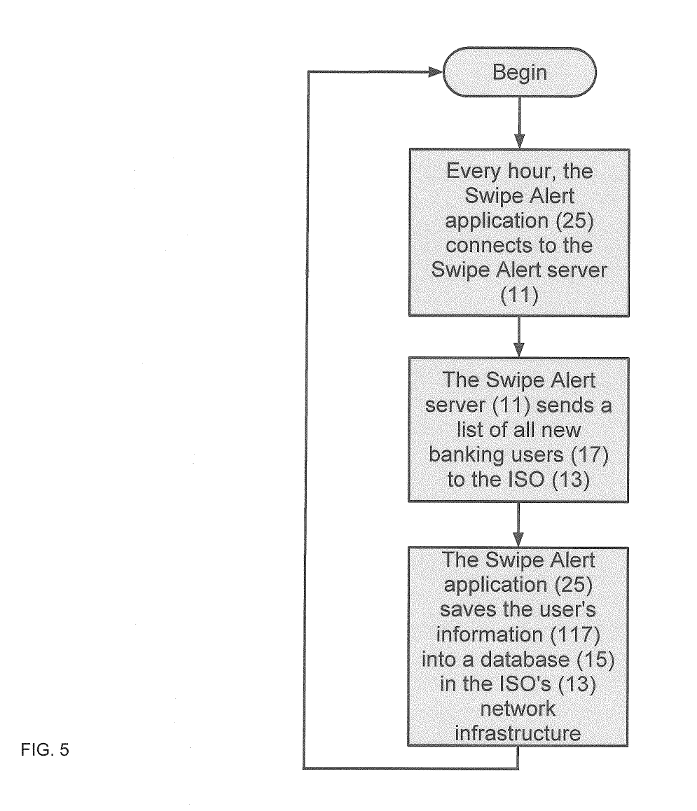

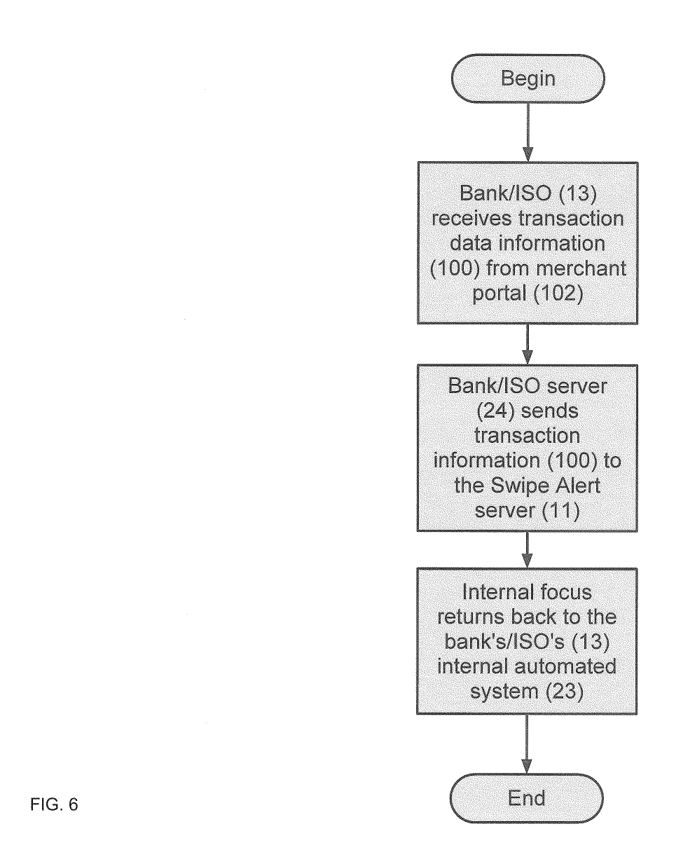

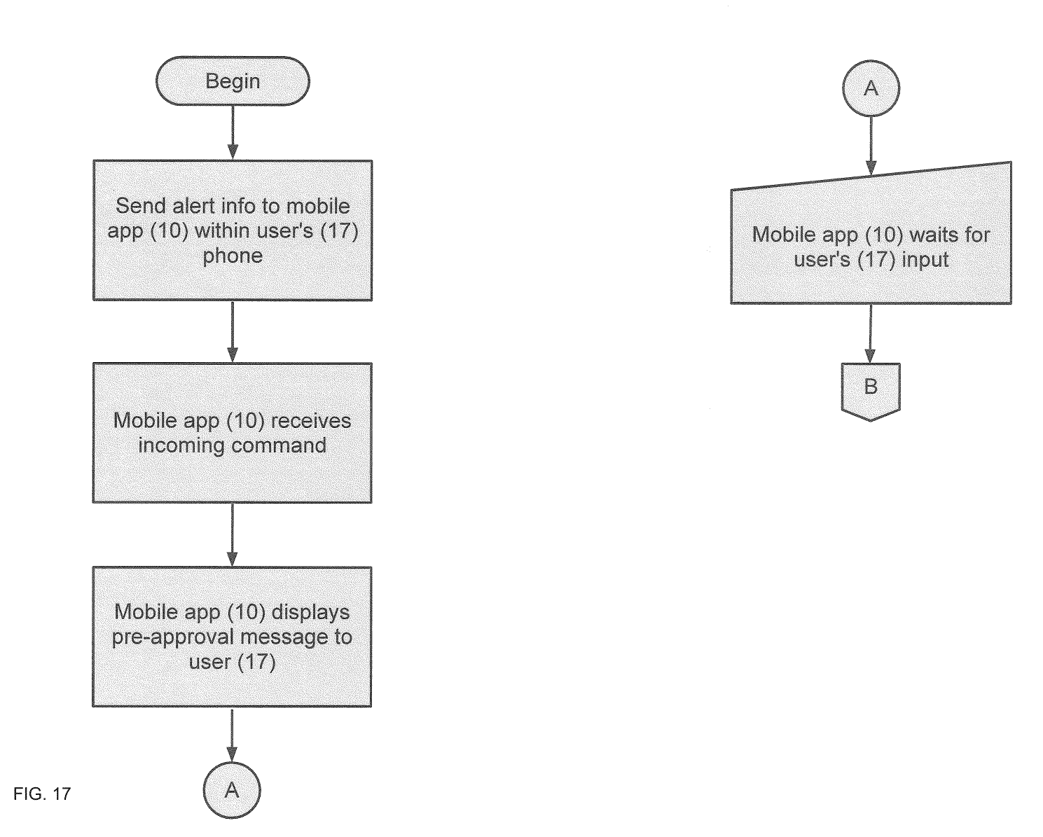

Referring to FIG. 5 through FIG. 19, flowcharts of the operation of the mobile application of the present invention 10 are shown. FIG. 5 shows the application download of user information into the ISO's database. With a predetermined frequency (i.e., every hour), the application connects to the server. After establishing the connection, the server sends a list of all new banking users to the ISO. The application then saves the user's information into a database in the ISO's network architecture. Referring to FIG. 6, a bank server 24 or ISO server 24 (not shown) receives transaction data or transaction information 100 from a merchant's portal 102. The transaction data 100 includes an authorization request from the merchant. The bank's or ISO's internal risk assessment algorithm (not shown) then determines if, in addition to signaling the mobile application server 11 to send an “approved” or “declined” notification to the mobile app on the user's smartphone 20, one or more of the prompts (not shown) should be triggered by the mobile application software 25. The bank's or ISO's internal risk assessment algorithm determines which prompts it desires to be active on the mobile application 10. In the preferred embodiment, the determination as to whether to approve or decline a merchant's request for a transaction is performed by the bank's or ISO's internal risk assessment algorithm. However, if the user 17, ISO 13 or bank 13 has selected a preapproval prompt (not shown) on his or her mobile application profile, the bank or ISO 13 does not make a determination or send an approval or decline notice to the merchant until the bank's or ISO's server 24 has communicated the preapproval request to the mobile application server 11. The mobile application software 25 then sends the preapproval request to the user's smartphone 20 and the user 17 sends the appropriate or desired response. Once the response is sent back to the bank or ISO 13 via the mobile application server 11, the bank or ISO 13 then sends the approval or decline notice to the merchant's portal 102. If the bank's server 24 or ISO's server 24 does not receive a response from the mobile application server 11 within a time period set by the bank's/ISO's 13 mobile app profile, the default response sent by the bank/ISO's server 24 to the merchant's portal 102 is to decline the transaction.

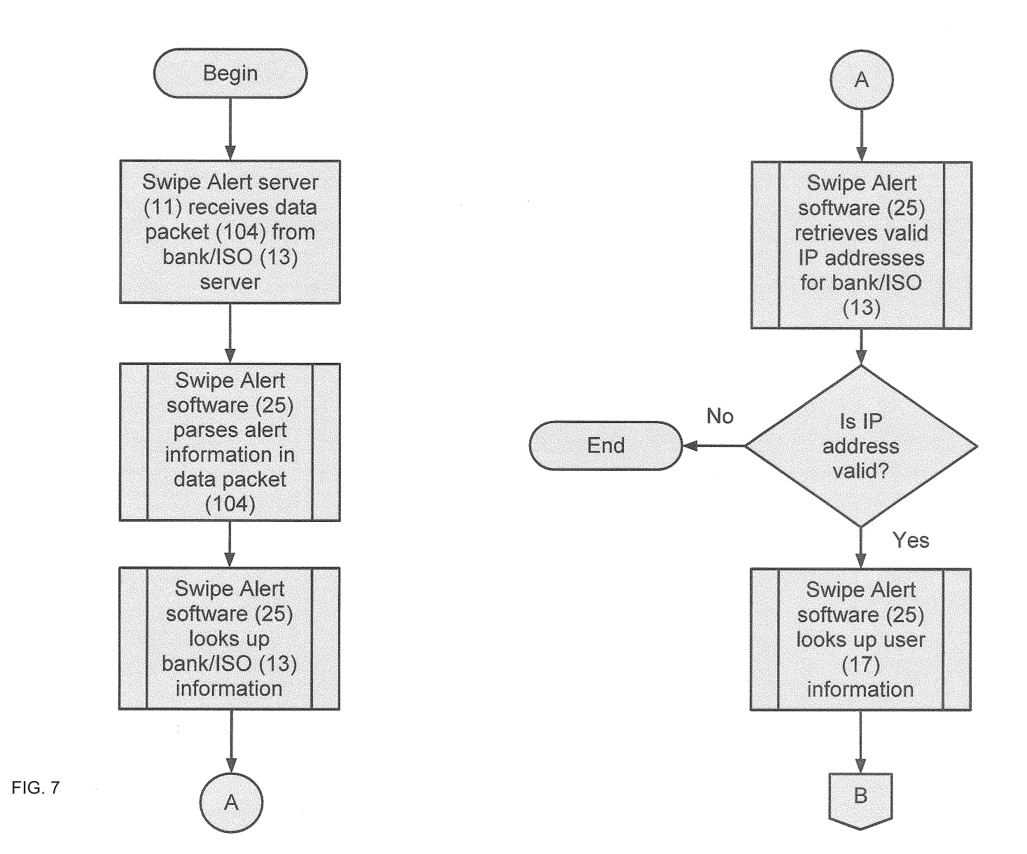

After receiving the transaction data 100, including any predefined prompts, the bank's or ISO's server 24 retrieves information off of its own database (not shown) and creates a data packet 104 (see FIG. 7) to send to the mobile application server 11. The data packet 104 comprises the bank's or ISO's user name and password, the user's user name, the merchant's name and transaction amount, the last four digits of the user's credit card. The data packet 104 may also include the IP address of the bank or ISO 13 so that the mobile application may authenticate the request being sent by the bank or ISO 13, time and date stamp of the transaction, merchant information such as the merchant type, postal address, and GPS coordinates of the merchant, the user's available balance or current balance, or a transaction identification. Information needed related to any of the predefined prompts is also requested through the data packet 104, which indicates to the mobile application software 25 what processes to activate related to the predefined prompts. After creating the data packet 104, the bank's server 24 or ISO's server 24 communicates the data packet 104 over the internet to the mobile application server 11.

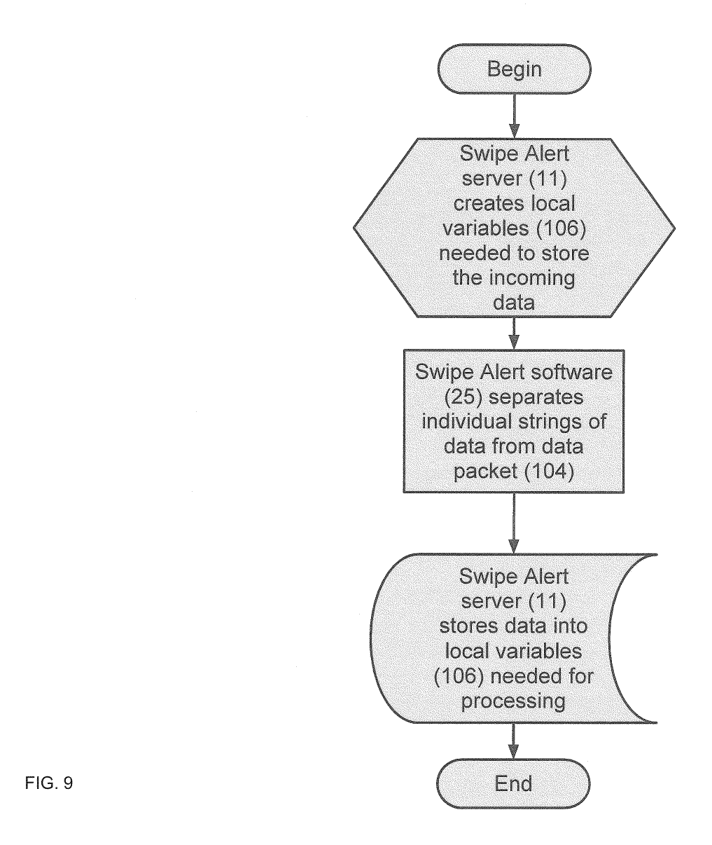

Referring to FIG. 7 and FIG. 9, once the data packet 104 is received by the mobile application server 11, the mobile application software 25 executes the transaction data 100 in the data packet 104, and then returns the focus to the bank's or ISO's server 24. After the data packet 104 sent by the bank's or ISO's server 24 is executed, the mobile application software 25 reads the transaction information 100 to determine what information is being received, along with any requests associated with the predefined prompts. As shown in FIG. 9, the mobile application software 25 executes source code to create local variables 106 to store the relevant or needed incoming data in the mobile application database 15. After the local variables 106 are created, the mobile application software separates the data strings, from the transaction information 100, and stores them into the local variables 106 within the mobile application software 25.

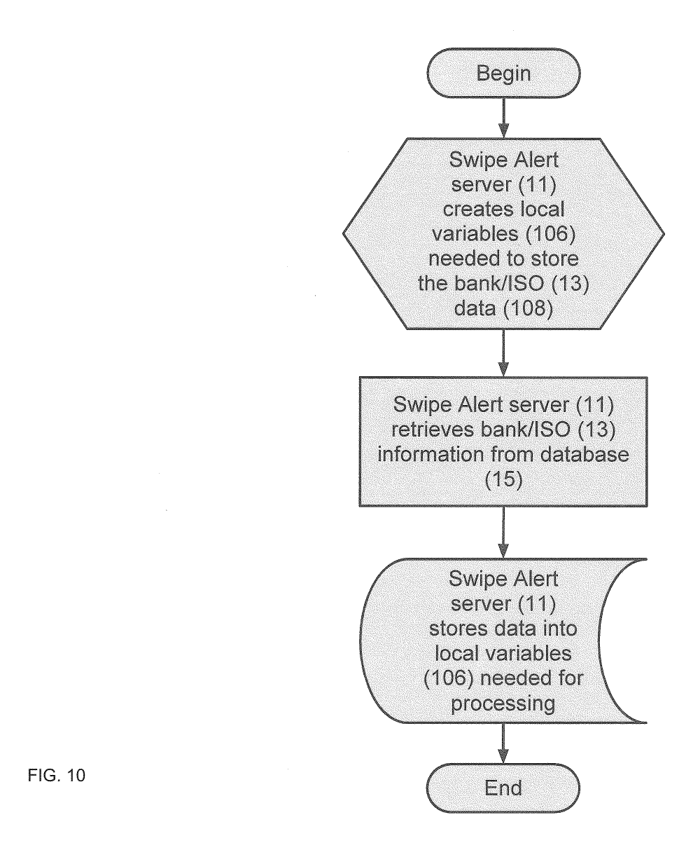

Referring to FIG. 7 and FIG. 10, after parsing the transaction information 100, the mobile application server 11 then verifies both the bank's or ISO's and the user's accounts. Once verified, the mobile application server 11 retrieves preference filters related to the predefined prompts from the user's profile in the mobile application database 15. The mobile application server 11 creates the local variables 106 needed to store the bank's or ISO's data 108, retrieves the bank's or ISO's data 108 from the mobile application database 15, and stores the data 108 into the local variables 106 for processing.

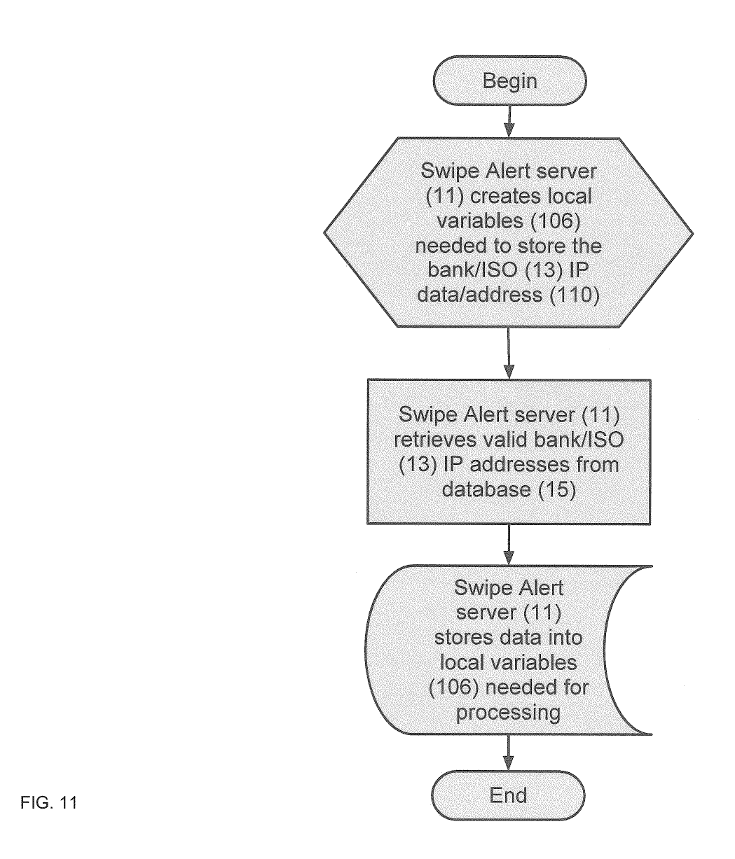

Referring to FIG. 7 and FIG. 11, after storing the bank or ISO data 108 into the variables 106 for processing, the mobile application server 11 retrieves and validates the IP addresses from the bank or ISO 13 through the internet connection between the bank or ISO server 24 and the mobile application server 11. The mobile application server 11 creates local variables 106 to store the bank's or ISO's IP address 110, retrieves the IP address 110 from the bank's or ISO's server 24, verifies the address 110, and stores the data in the local variables 106 for processing. If the IP address 110 from the bank or ISO 13 is not validated, the mobile application server returns an error code and the process 12 ends. If the IP address 110 is validated, the mobile application software 25 accesses the mobile application database 15 to retrieve the user's information 112.

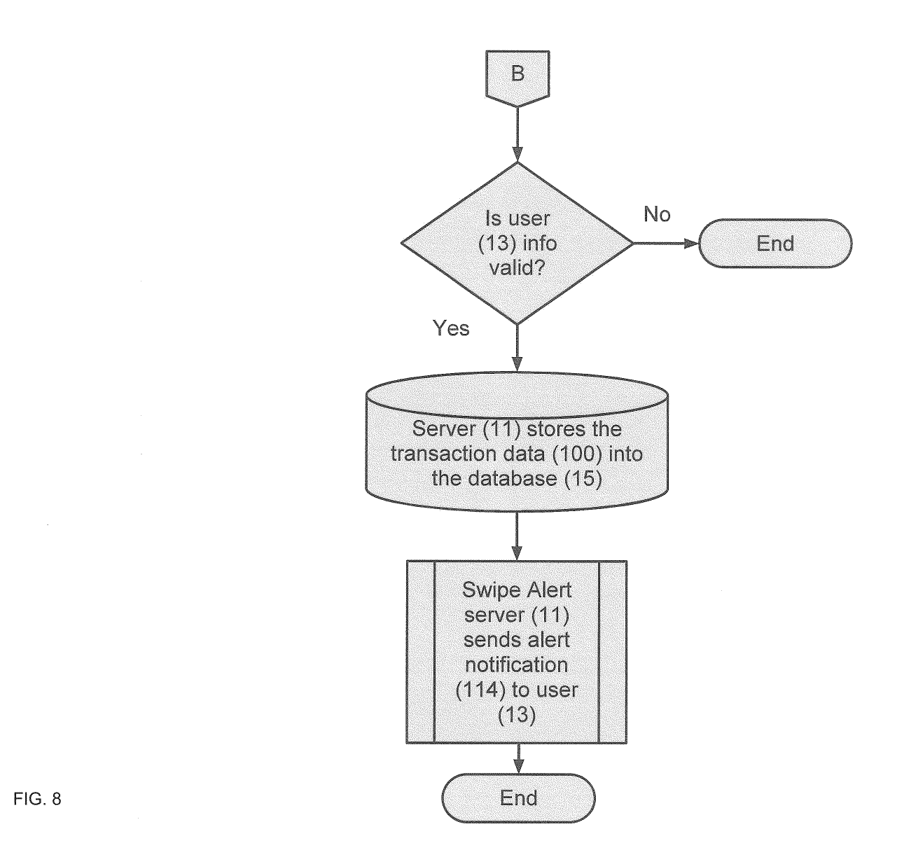

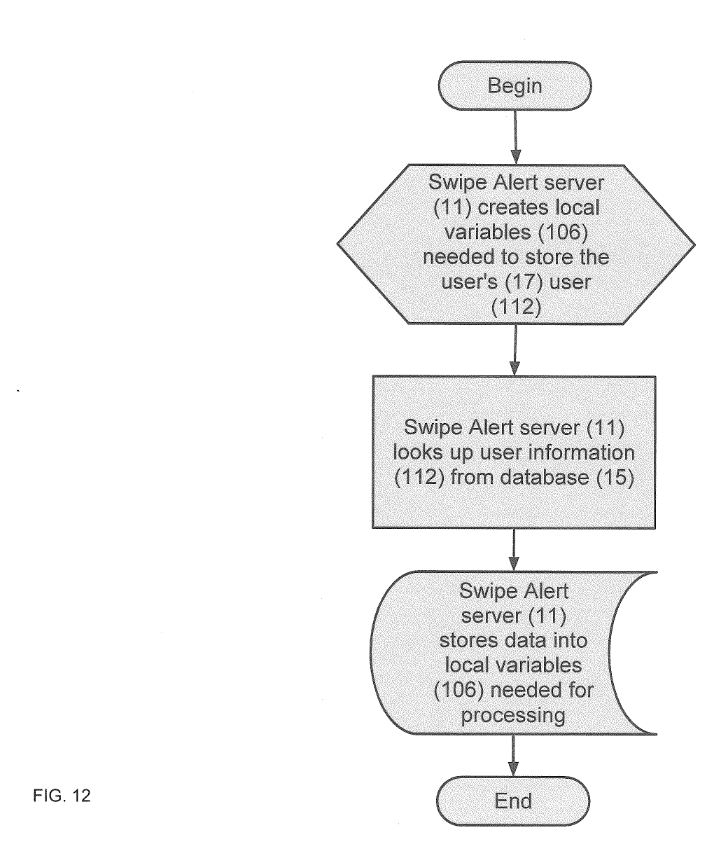

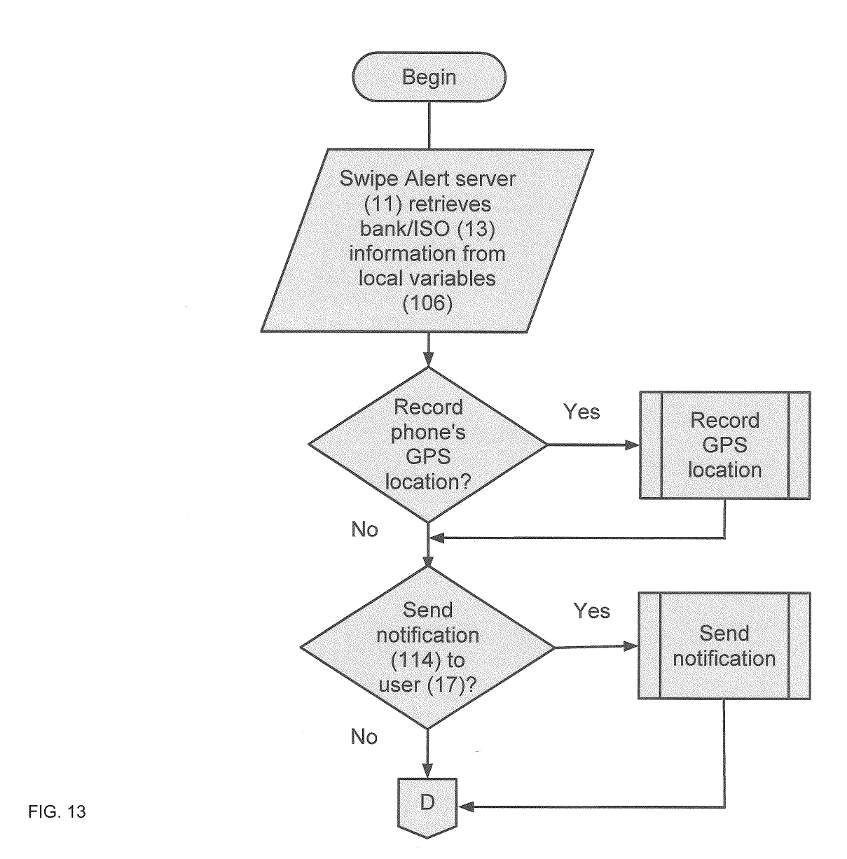

Referring to FIG. 12, the mobile application server 11 creates local variables 106 needed to store the user's information 112 for processing, and retrieves the user's information 112 from the user's profile within the database 15, and stores that data into the local variables 106 for processing. Referring to FIG. 8 and FIG. 13, once the user information 112 is retrieved and stored onto the local variable 106 for processing, the user information 112 is validated and the transaction data 100 is stored into the mobile application database 15. Once the local variables 106 storing (a) the parsed transaction data 100, (b) the bank's or ISO's IP address and data 108, and (c) the user information 112 are ready for processing, the mobile application software 25 communicates with the user's mobile app 20 to send an alert notification 114. The mobile application software 25 looks up the preference filters of the user 17 to determine if the notification 114 is to be passed along to the user 17, and which of the processes or notifications 114 from the predefined prompts should be passed to the user's smartphone.

After this is done, the mobile application server 11 retrieves the information from the variables 106 stored in the database 15 to create a data packet 104 to send to the user's mobile app 20. The data packet 104 comprises the bank's or ISO's 13 identity or name, the merchant's name and the transaction amount, and the last four digits of the user's credit card. The data packet 104 may also include the time and date stamp of the transaction, merchant information such as the merchant type, postal address, and GPS coordinates of the merchant, the user's available balance or current balance, or transaction identification. Based on the user's profile related to the predefined prompts, information needed related to any of the predefined prompts is also included in the data packet 104, indicating to the mobile app 20 on the user's smartphone which processes to activate. The prepared data packet 104 is then communicated via internet connection to the user's mobile app 20.

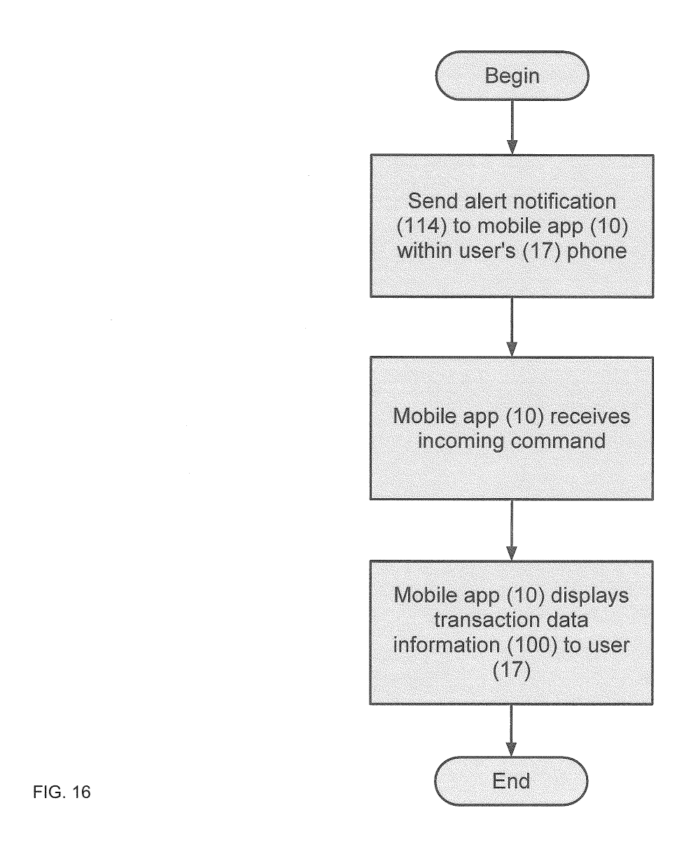

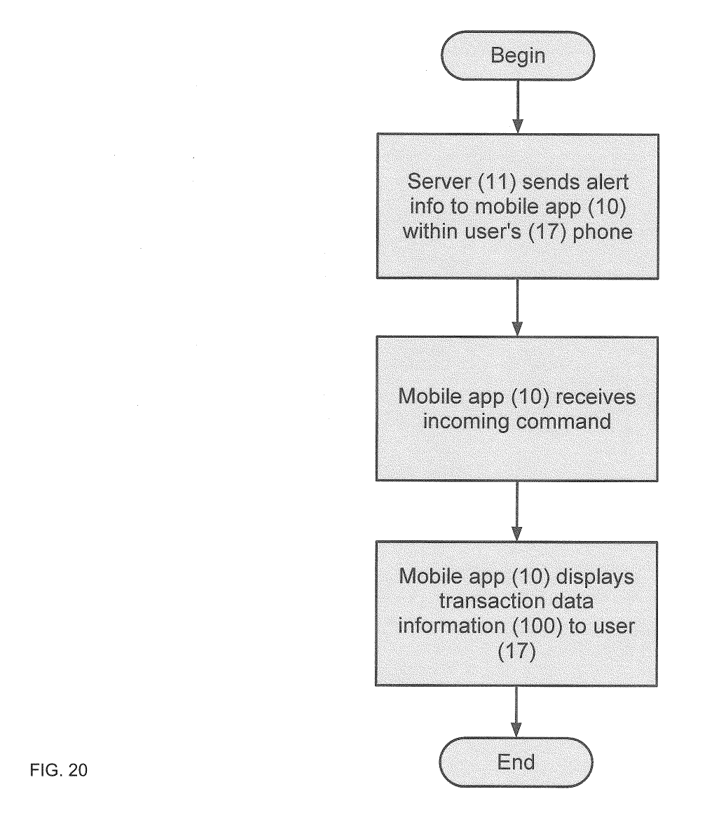

Referring to FIG. 13, FIG. 16, and FIG. 20, upon receiving the data packet 104 from the mobile application server 11, the mobile app 20 on the user's smartphone determines what information is being passed, along with one or more of the predefined prompts according to the preferences of the user's profile. The mobile app 20 on the user's smartphone displays an alert notification 114 contained in the data packet 104 to the user's mobile app 20 for display on the user's smartphone, notifying the user 17 that his or her bank account has been accessed via his or her credit card or debit card information. In one embodiment, the alert notification 114 is sent every time the user's debit or credit card is used. In another embodiment, the alert notification 114 is sent only when one or more predefined parameters are met, such as dollar amount, location of the transaction, or number of transactions per day.

The predefined parameters are set by the mobile application server 11 in one embodiment. In another embodiment, the predefined parameters are set by the bank or ISO 13 and communicated from the bank's or ISO's server 24 to the mobile application server 11. In the preferred embodiment, the predefined parameters are set by the user 17 when the user profile is set up, and may be amended by the user 17 through web interface by accessing the mobile application's website 21 through the internet and logging in to his or her profile.

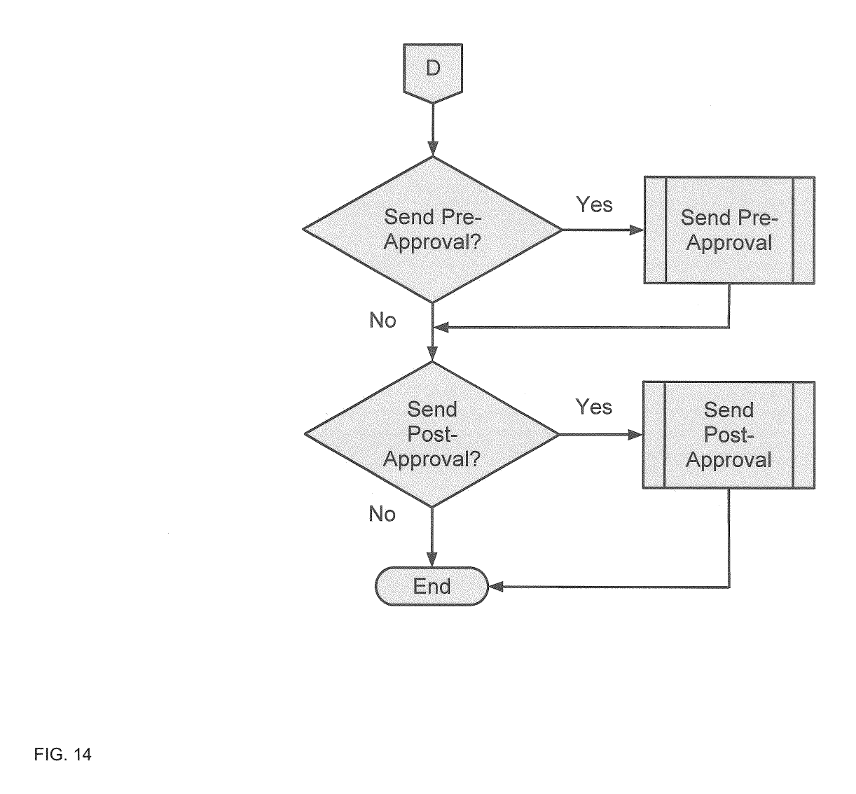

Referring to FIG. 16, in one embodiment, the alert notification 114 is sent from the mobile application server 11 to the user's mobile app 20 which displays the alert notification 114 on the user's smartphone as the transaction is occurring. The alert notification 114 may provide, alone or in combination, the amount of the transaction, the date, the location (address), and the merchant's name. Referring to FIG. 14 and FIG. 20, in another embodiment, the alert notification 114 is sent from the mobile application server 11 to the user's mobile app 20 which displays the alert notification 114 on the user's smartphone after the transaction has been completed (post-approval 118). Again, the alert notification 114 may provide, alone or in combination, the amount of the transaction, the date, the location (address), and the merchant's name. In another embodiment, the notification 114 displayed on the user's smartphone includes a data field for the bank's telephone number wherein the user may select the data field, and the smartphone will call the bank's or ISO's 13 designated customer service telephone. In another embodiment, the notification 114 displayed on the user's smartphone includes a prompt to send an electronic notification of fraud or potential fraud through the mobile application server 11 to the bank's or ISO's server 24 to notify the bank or ISO 13 of fraud or potential fraud.

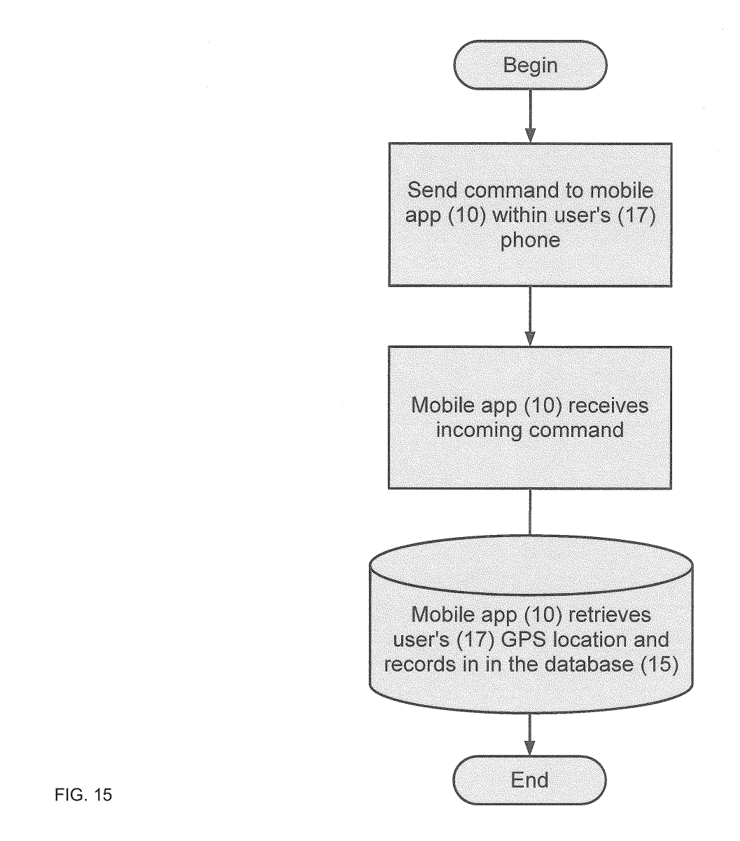

Referring to FIG. 13 and FIG. 15, in one embodiment, if the GPS function is selected by the bank or ISO 13 for use in the user profiles of the bank's customers, the mobile application server 11 sends a command in the data packet 104 to record the GPS coordinates or location 200 of the user's smartphone 20 using the smartphone's GPS module at the time of the sending of the alert notification 114. The mobile app 20 sends the GPS coordinates to the mobile application software 25, which stores the information in the mobile application database 15. It should be understood to one of ordinary skill in the art that the GPS command may be selectively activated or deactivated, based on the bank's, ISO's or user's preference.

Referring to FIG. 14 and FIG. 17 through FIG. 19, the pre-approval 116 embodiment of the present invention is disclosed. In this embodiment, after the transaction data 100 is received, parsed and stored in the local variables 106 for processing on the mobile application server 11, the mobile application server 11 sends the alert notification 114 to the user's mobile app 20 for display on the user's smartphone prior to the transaction being completed. The user's mobile app 20 displays a data field requesting the user 17 to enter his or her PIN number or password 202 to verify the charge.

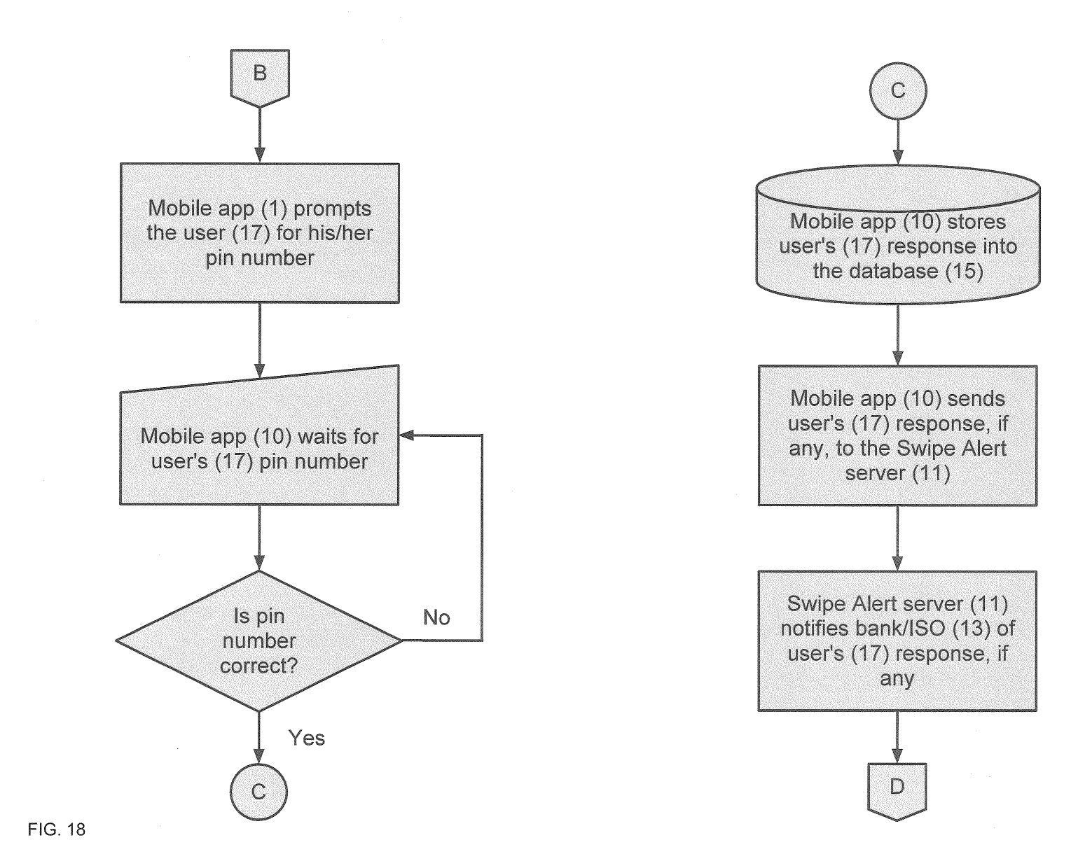

As shown in FIG. 18, after the PIN number 202 is entered, the notification 114 requests the user 17 to input, preferably by touching a graphical icon (not shown) on the smartphone or a button (not shown) corresponding and controlling the graphical icon, a responsive command 204. The responsive command 204 may be either an “Accept” command (or other similar approval command) or a “Decline” command (or other similar command). An “Unsure” (or other similar command) may also be provided as a responsive command 204. Once the PIN number or password 202 and responsive command 204 (“Accept”, “Decline” or optionally “Unsure”) are entered, the PIN number or password 202 is verified by comparing to the PIN number or password 202 in the mobile application database 15. Once verified, responsive command 204 is sent to the bank's or ISO's server 24. If the PIN number or password 202 is not verified, then an error message (not shown) is sent to the user's mobile app 20 on the user's smartphone informing the user 17 to re-enter the PIN number 202. If three incorrect PIN numbers 202 are entered in a row, the user's mobile app 20 is locked by a command sent from the mobile application server 11, and must be released by the user 17 by accessing the mobile application website. The mobile application server 11 then sends the bank or ISO 13 an error code (not shown) indicating that three PIN attempts have been made, and that all three attempts have failed. The bank's or ISO's server 24 then sends a decline response to the merchant.

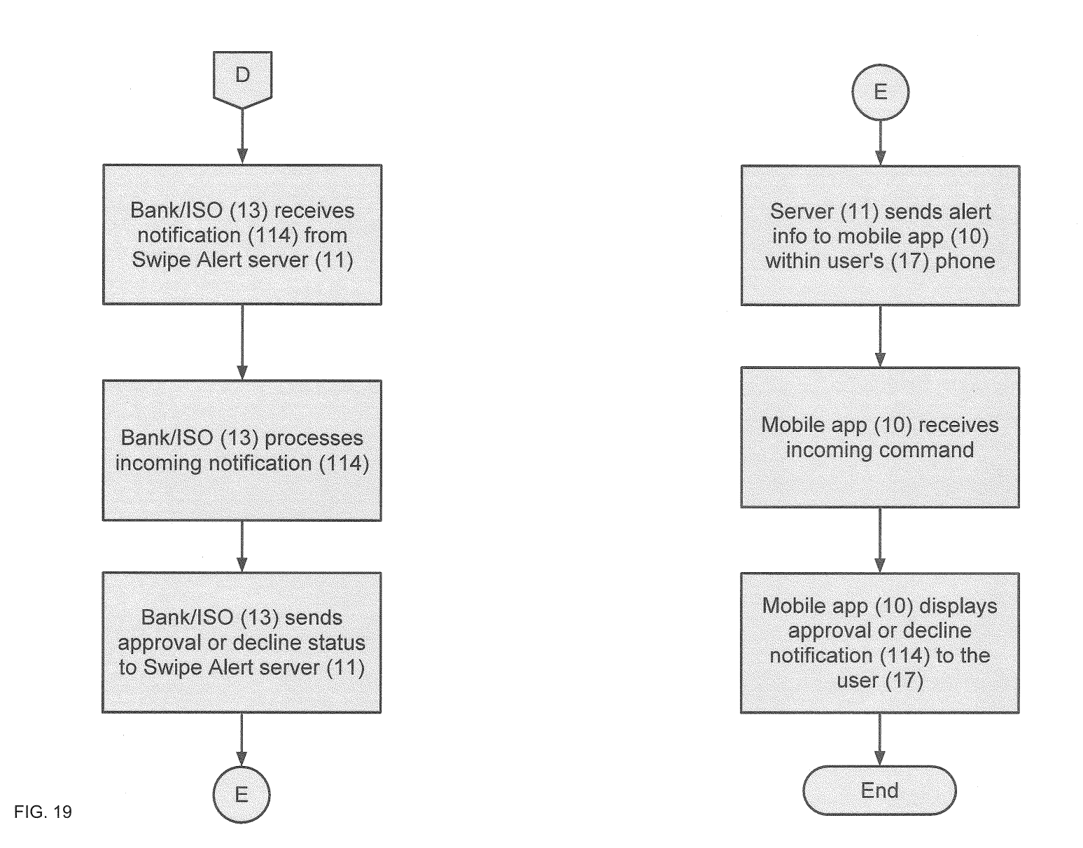

Referring to FIG. 18 and FIG. 19, once the bank's or ISO's server 24 receives the user's responsive command 204, the bank's or ISO's server 24 processes the responsive command 204 and either declines or accepts the transaction based on the user's responsive command 204. After declining or approving the transaction, the bank's or ISO's server 24 may send the resulting approval or decline status 206 to the mobile application server 11, which will send the finalized approval or decline status 206 to the mobile app 20 on the user's smartphone.

In addition to displaying the transaction information prior to completing the transaction, in an alternative embodiment, the mobile application server 11 may send an alert notification 114 requesting the user 17 to confirm a transaction that has already occurred. The user interface on the mobile app 20 on the user's smartphone for post approval alert 118 (see FIG. 14) works the same as described with regard to the preapproval alert 116 described hereinabove.

In another embodiment, once the user 17 reports the fraudulent transaction to the mobile application server 11 by using the mobile application 10 as described hereinabove, the mobile application server 11 may send a fraud notice to the merchant, provided that the merchant is subscribed to the mobile application of the present invention 10 as well. The data packet 104 includes the transaction ID and is sent from the mobile application server 11 to the merchant's server or portal 102.

Finally, it should be understood that the mobile application website 21 is provided in conjunction with the mobile application 10. The website 21 allows the user 17 to log in using a secure user name and password (either assigned to or selected by the user when setting up his or her profile). Once securely logged in, the user 17 may monitor and change a variety of parameter filters. Moreover, the user 17 may access his or her password or pin number and parameter filters from the mobile application 20 on the user's smartphone as well. The user 17 may save or delete all or part of his or her account activity from the mobile application database 15, or change the various parameters controlling when the mobile application 10 is to send alert notifications 114 to the user's smartphone.

Although the invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. Such modifications or alternative embodiments within the scope of this invention include, but are not limited to, using the mobile application 10 to detect checks drawn on an account, electronic funds transfers, automated clearing house (ACH) payments, as well as wire transfers. It is contemplated that the appended claims will cover modifications and alternative embodiments that fall within the scope of the invention.

We claim:

1. A method for monitoring financial transactions drawn on financial accounts comprising:
receiving on a monitoring server at least one transaction data packet from a financial institution's server, said financial institution's server being in communication with said monitoring server, said transaction data packet comprising a plurality of data strings in a computer readable format;
executing a first set of instructions within a software program loaded on said monitoring server to create a plurality of variables within a monitoring database, said monitoring database being in communication with said monitoring server;
separating and reading said plurality of data strings from said transaction data packet by executing a second set of instructions within said software program;
storing said plurality of data strings within said plurality of variables in said monitoring database;
comparing said data strings to a predefined set of parameters of a user profile, said user profile being stored in said monitoring database;
generating a responsive command based on said comparing step by executing a third set of instructions within said software to generate said responsive command; and
sending said responsive command from said monitoring server to said financial institution's server;
wherein said plurality of variables are stored within said user profile in said monitoring database.

2. The method for monitoring financial transactions as recited in claim 1 wherein said plurality of data strings comprise data, alone or in any combination, selected from the group consisting of transaction amount, transaction date, transaction time, merchant name, or merchant location.

3. The method for monitoring financial transactions as recited in claim 2 comprising sending an alert notification to a mobile application on a user's smartphone after said comparing step, said sending step comprising:
retrieving said data strings from said plurality of variables by executing a fourth set of instructions within said software;
assembling a user notification data packet comprising said data strings by executing a fifth set of instructions within said software; and
sending said user notification data packet from said monitoring server to said mobile application, said mobile application being in communication with said monitoring server.

4. The method for monitoring financial transactions as recited in claim 3 wherein said mobile application receives said user notification data packet, reads and separates said plurality of data strings and displays said alert notification on said smartphone.

5. The method for monitoring financial transactions as recited in claim 4 wherein:
said user notification data packet comprises data strings comprising responsive command data;
said mobile application displays responsive command data on said smartphone for selection of a responsive command by said user; and
said responsive command data comprises an approval responsive command and a decline responsive command.

6. The method for monitoring financial transactions as recited in claim 5 wherein said mobile application sends said responsive command to said monitoring server after said user selects said responsive command, said sending said responsive command step comprising:
receiving a selection of a responsive command from said user;
creating a responsive command data packet from said responsive command; and
sending said responsive command data packet to said monitoring server.

7. The method for monitoring financial transactions as recited in claim 6 further comprising:
said monitoring server storing said responsive command data packet into said plurality of variables in said database; and
said monitoring server sending said responsive data packet to said financial institution intermediate database.

8. The method for monitoring financial transactions as recited in claim 5 wherein said responsive command is selected by said user prior to completion of said financial transaction.

9. The method for monitoring financial transactions as recited in claim 5 wherein said responsive command is selected by said user after completion of said financial transaction.

10. The method for monitoring financial transactions as recited in claim 3 wherein:
said mobile application displays a pin code prompt prior to said sending step for entry of a pin code and sends said pin code to said monitoring server
said monitoring server stores said entered pin code in said database and executes a sixth set of instructions to verify said entered pin code.

11. The method for monitoring financial transactions as recited in claim 3 further comprising the steps of the mobile application:
accessing a smartphone's GPS function and obtaining a GPS location of said smartphone; and
sending said GPS location to said monitoring server;
wherein said monitoring server saves said GPS location in said database.

12. The method for monitoring financial transactions as recited in claim 1 further comprising:
verifying an internet protocol address of said financial institution at the time of said receiving step by said monitoring server executing a seventh set of instructions within said software to obtain said internet protocol address, and compare said internet protocol address of said financial institution with an internet protocol address of said financial institution stored in said database.

13. The method for monitoring financial transactions as recited in claim 3 further comprising:
verifying an internet protocol address of said user's smartphone at the time of said sending step by said monitoring server executing an eighth set of instructions within said software to obtain from said mobile application said internet protocol address, and compare said internet protocol address of said user with an internet protocol address of said user stored in said database.

14. A system for monitoring financial transactions drawn on financial accounts comprising:
a monitoring server in communication with a financial institution's server, a monitoring database, and at least one mobile application of at least one smartphone wherein:
said financial institution's server communicates with said monitoring server to send at least one transaction data packet, said transaction data packet comprising a plurality of data strings in a computer readable format;
said monitoring server executes a first set of instructions within a software program loaded on said monitoring server to create a plurality of variables within said monitoring database;
said monitoring server separates and reads said plurality of data strings from said transaction data packet by executing a second set of instructions within said software program, and stores said plurality of data strings within said plurality of variables in said monitoring database;
said monitoring server compares said data strings to a predefined set of parameters of a user profile, said user profile being stored in said monitoring database;
said monitoring server sends an alert notification to said mobile application by retrieving said data strings from said plurality of variables by executing a third set of instructions within said software, assembling a user notification data packet comprising said data strings by executing a fourth set of instructions within said software, and sending said user notification data packet from said monitoring server to said mobile application; and
said plurality of variables are stored within said user profile in said monitoring database.

15. The system for monitoring financial transactions as recited in claim 14 wherein said plurality of data strings comprise data, alone or in any combination, selected from the group consisting of transaction amount, transaction date, transaction time, merchant name, or merchant location.

16. The system for monitoring financial transactions as recited in claim 15 wherein said mobile application receives said user notification data packet, reads and separates said plurality of data strings and displays said alert notification on said smartphone.

17. The system for monitoring financial transactions as recited in claim 15 wherein
said user notification data packet comprises data strings comprising responsive command data;
said mobile application displays responsive command data on said smartphone for selection of a responsive command by said user; and
said responsive command data comprises an approval responsive command and a decline responsive command.

18. The system for monitoring financial transactions as recited in claim 17 wherein:
said mobile application sends said responsive command to said monitoring server after said user selects said responsive command by receiving a selection of a responsive command from said user, creating a responsive command data packet from said responsive command and sending said responsive command data packet to said monitoring server; and
said monitoring server stores said responsive command data packet into said plurality of variables in said database and sends said responsive data packet to said financial institution intermediate server.

19. The system for monitoring financial transactions as recited in claim 17 wherein said responsive command is selected by said user prior to completion of said financial transaction.

20. The system for monitoring financial transactions as recited in claim 17 wherein said responsive command is selected by said user after completion of said financial transaction.
